(19) United States
(12) Patent Application Publication
(10) Pub. No.: US 2003/0009486 A1
(43) Pub. Date: Jan. 9, 2003

(54) Data reducing method, system and program

(75) Inventors: Naoki Shimada, Yokohama (JP); Motoaki Hirabayashi, Yokohama (JP); Takashi Ohfuji, Yokohama (JP)

Correspondence Address: McDermott, Will & Emery, 600 13th Street, N.W., Washington, DC, 20005-3096, US

(73) Assignee: Hitachi, Ltd.

(21) Appl. No.: 10/180,533

(22) Filed: Jun. 27, 2002

(30) Foreign Application Priority Data
Jul. 3, 2001 (JP) 2001-201885

(51) Int. Cl. G06F 17/30

(52) U.S. Cl. 707/200

(57) ABSTRACT

There are provided method, system and program for decreasing the amount of information by causing a distributor or user to determine a period for retention of digital information in advance and deteriorating digital information lowered in utilization value as the time elapses. The digital information is assigned with a compression ratio or a period for retaining the information amount (life). As the time elapses, old information is reduced in accordance with a degree of importance of the digital information. Deterioration has the meaning of erasing a predetermined item of the digital information or compressing the digital information through a predetermined method. By deteriorating the information, the information amount can be reduced.

### BACKGROUND OF THE INVENTION

The present invention relates to techniques for storage of digital information and more particularly, to a data reducing method adapted to decrease the capacity for storage of information by reducing accumulated digital information as the time elapses and system and program therefore.

In computers, an application program is executed or data is stored and retrieved for display. In order to manage correct execution of the application program, a record of execution is often left behind as a log in a file. Besides, in order for a plurality of computers to be managed by a single management computer through a network, the contents of a log is notified as an event to the management computer and then, the management computer carries out accumulation of the event.

At present, it is generally practiced that a Web page is consulted through the Internet or intranet or data of documents, static images and motion pictures or a file of program are downloaded.

Typically, digital information such as events and images is in the custody of, for example, a hard disk controlled on a computer of a user and when becomes unneeded, it is erased by the user.

Characteristically, however, the digital information accumulated as described above does not change with time and it remains to exist in the hard disk unless erased manifestatively by the user. The capacity of the hard disk increases year by year but digital information increases likewise. Supposedly, if the capacity is sufficiently large, manual management of the hard disk becomes difficult to achieve at present. Under the circumstances, information remains in excess of a constant period is erased unconditionally but information once erased cannot be recovered again and problematically, it can never be seen later. Further, the disk occupation amount can be decreased through a method such as data compression but compression of character information such as events is limitative.

JP-A-6-35764 and JP-A-10-260875 each disclose a technique of partially erasing a record or file in accordance with the lapse of time. The technique described in the above gazettes, however, can proceed with only a single process complying with the lapse of time. Inconveniently, therefore, the information is uniformly erased in accordance with the lapse of time regardless of its importance or unimportance. In addition, JP-A-2001-101234 discloses a method, according to which degrees of importance are set to a plurality of attribute items constituting a database and when discard of record becomes necessary, an unnecessary record is determined in accordance with its degree of importance. The technique, however, lacks the concept concerning the time lapsed.

### SUMMARY OF THE INVENTION

The present invention contemplates elimination of the problems encountered in the above conventional techniques and has its object to provide a method capable of having the custody of important information for a long period of time and decreasing the information amount of digital information and besides, capable of permitting a distributor or user to determine a period for retention of digital information in advance with the aim of automating management of the information and capable of reducing the information amount by deteriorating digital information of lowered utilization value in accordance with its aging change to decrease the information amount. The invention also intends to provide system and program for the method as above.

To accomplish the above object, a digital information deteriorating method for reducing the amount of digital information according to the invention comprises the steps of deciding degrees of importance of accumulated digital information, and reducing the amount of the digital information by erasing a predetermined item of the digital information in accordance with a determined degree of importance as the time elapses or compressing the digital information.

A digital information deteriorating system for reducing the amount of digital information according to the invention comprises means for accumulating digital information, means for storing degrees of importance of the digital information, and means for reducing the amount of the digital information by detecting degrees of importance of the digital information as the time elapses, erasing a predetermined item of the digital information in accordance with a detected degree of importance or by compressing the digital information.

A program concerning the digital information deteriorating method for reduction of the amount of digital information comprises the steps of deciding degrees of importance of accumulated digital information, and reducing the amount of the digital information by erasing a predetermined item of the digital information in accordance with a determined degree of importance as the time elapses or by compressing the digital information.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of construction of a system to which a digital information deteriorating method according to a first embodiment of the present invention is applied.

FIG. 2 is a diagram showing an example of an event stored in an event accumulative file.

FIG. 3 is an exemplified flowchart of the flow in an information amount reduction process.

FIG. 4 shows an example of the accumulative file to which the information amount reduction process is applied.

FIG. 5 is a diagram showing an example of overall construction of a system according to a second embodiment of the invention.

FIG. 6 shows an example of an image management table.

FIGS. 7A, 7B and 7C are diagrams showing the behavior of image compression.

FIG. 8 is a diagram showing an example of overall construction of a third embodiment according to the invention.

FIGS. 9A, 9B and 9C are diagrams showing examples of an automatic response definition file.

FIGS. 10A and 10B are diagrams showing examples of information stored in the event accumulative file.

FIG. 11 is an exemplified flowchart of a process in an automatic response processor.

FIG. 12 is a diagram showing another example of overall construction of the third embodiment according to the invention.

### DESCRIPTION OF THE EMBODIMENTS

Embodiments of the present invention will now be described with reference to the accompanying drawings.

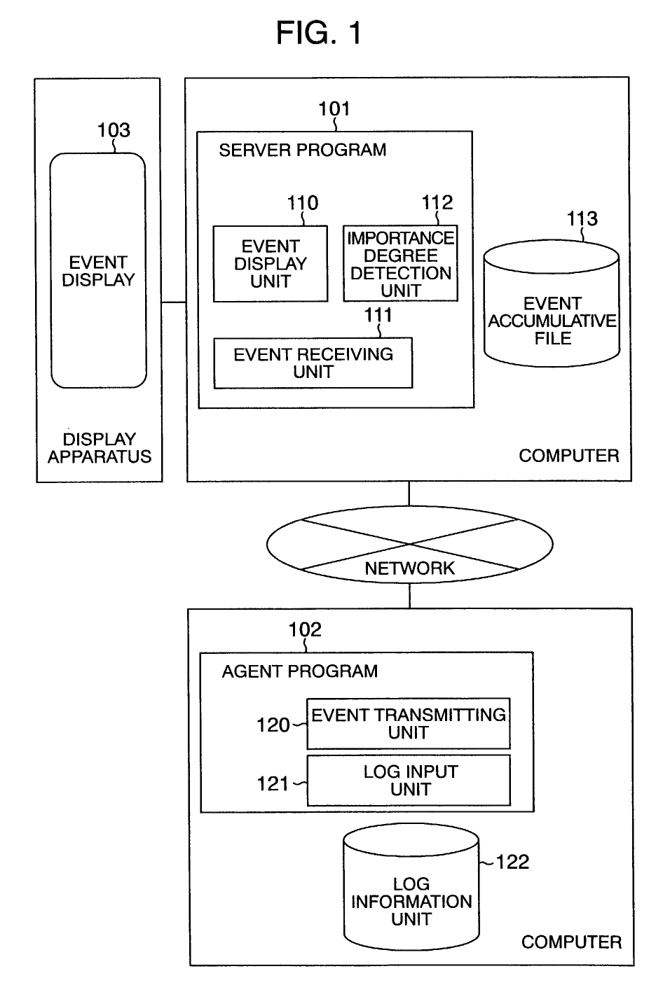

FIG. 1 is a diagram showing the construction of a system to which a digital information deteriorating method according to a first embodiment of the invention is applied. A server program 101 is a program used to receive and accumulate events (the event means information concerning an event occurring in a computer or program) and enable a user to watch them in a comprehensible format, and it has an event display unit 110, an event receiving unit 111, an importance degree detection unit 112 and an event accumulative file 113. Although not illustrated, each computer includes hardware resources (memory, CPU and the like) and software resources (operating system and the like) necessary for implementing the present invention.

An agent program 102 is a program executed in the computer on which various programs to be managed such as application programs and DBMS (database management program) are operating. The agent program 102 generates an event and a message and transmits them. The agent program 102 includes an event transmitting unit 120, a log input unit 121 and a log information file 122. An event display 103 indicates an event or events displayed on the screen of a display apparatus.

Various kinds of information collected by an application program or the like executed by the computer on which the agent program 102 is operating are accumulated as log information file 122. The log input unit 121 acquires from the log information file 122 information to be transmitted to the server program 101 when it receives a request from the server program 101 or a constant time has elapsed and processes the acquired information to transfer it to the event transmitting unit 120. Processing of the information acquired from the log information file 122 includes extraction of data from the log information file and addition of any information to the extracted data.

The event transmitting unit 120 makes the most use of hardware and programs necessary for inter-machine communication to transmit to the event receiving unit 111 of server 101 the information transferred from the log input unit 121. The event receiving unit 111 stores the received information (event) in the event accumulative file 113.

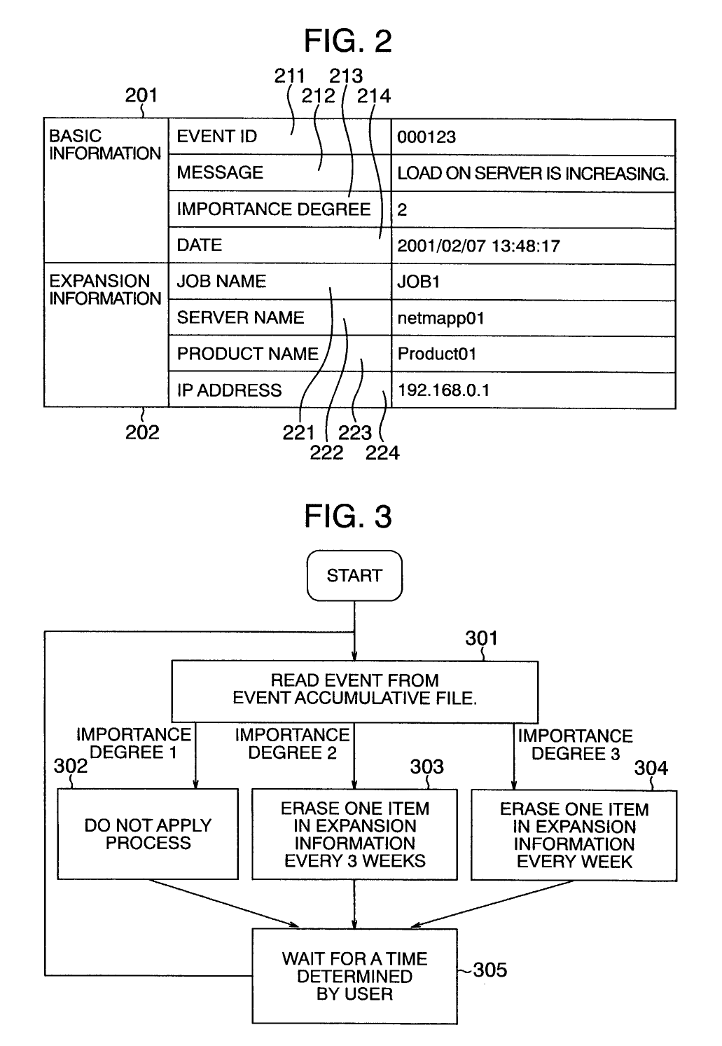

FIG. 2 is a diagram showing an example of an event stored in the event accumulative file 113. The event has basic information 201 and expansion information 202. The basic information 201 has items including event ID 211 for specifying the kind of event, message 212 indicative of the contents to be seen by a user (custodian), importance degree 213 for determining a degree of importance of the event per se, that is, an information amount reducing period, and date 214 of preparation of the event that is a round starting point of reduction. These items provide important information and the judgement on the reduction or the timing for reduction depends on the items.

The importance degree 213 has a value assigned in compliance with one of degrees of importance sorted according to the kinds of events. For example, an event of medium importance is assigned with a value “2” indicating that the information reduction is caused to proceed gradually. A value “1” indicates that the corresponding event is excluded from reduction.

The expansion information 202 has items of job name 221 in which the event occurs, server name 222, product name 223 and IP address 224 of the server. These items are of relatively unimportant information and they are reduction objects having high priority orders. The job means a process for executing a program with the computer and it is managed by making the correspondence between the job and the job name or job ID.

In an example of the priority orders owned by reduction objects per se, the IP address 224, product name 223, server name 222 and job name 221 may be ranked in this order, starting from higher priority order and the basic information may be excluded from reduction. The priority orders are tabulated and held in the importance degree detection unit 112.

The importance degree detection unit 112 searches the event accumulative file 113 every constant period (for example, every week) to detect an event that is in excess of the constant period and reduces the information amount on the basis of a value of item of importance degree 213.

An importance degree table may be prepared by using item values such as the importance degrees of events per se, the priority orders of reduction objects and the life of digital information and this importance degree table may be consulted to determine which item is to be reduced in accordance with the corresponding importance degree.

FIG. 3 is a flowchart showing an example of the flow in an information amount reduction process to be carried out by the importance degree detection unit 112. Firstly, in step 301, an event is read out of the event accumulative file 113. If the importance degree item of the read event is “1”, the program proceeds to step 302 and the item reduction process is not applied.

In other words, this event remains all the time. If the event has an importance degree item of “2”, a process is applied which reduces items one by one every three weeks in step 303.

For example, when the present date has 6 weeks elapsed from a date of preparation of the event, the two items of IP address and product name are erased in accordance with the priority orders of reduction objects. Actually, however, the item of IP address has already been erased at the expiration of three weeks. Similarly, when the importance degree is “3”, the items are reduced one by one every week in step 304.

After all events have been searched, the importance degree detection unit 112 retards the process for a time determined by the user, for example, one week in step 305 and when the period expires, begins with the step 301 to resume the process.

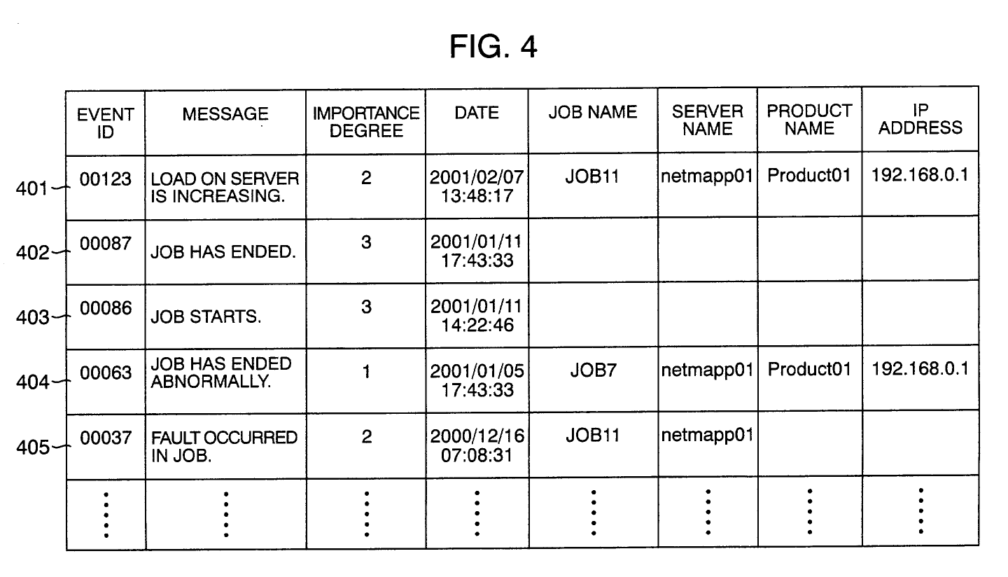

FIG. 4 shows an example of the event accumulative file applied with the information amount reduction process. Data exemplified herein is an example of information stored in the event accumulative file 113. Events, including one shown in FIG. 2, are arranged in column in such a manner that one event is indicated in row on one line. An even 401 having an ID of 00123 is dated recently and is not yet treated as an object to be reduced. In events 402 and 403 that have already gone through more than 4 weeks, having an importance degree of “3”, the four items of expansion information are erased. An event 404 having an importance degree of “1” is not applied with the process of erasing items. In an event “405” that is old but has an importance degree of “2”, reduction is applied limitedly to only lower two items. While an event having a high importance degree, though being old, keeps remaining, events having low importance degrees are reduced in accordance with the priority orders of reduction objects at the expiration of predetermined periods.

Typically, several thousands or several ten thousands of events as above are saved. When it is desired to raise the compression ratio, the reduction period can be decreased or items even in the basic information can be handled as reduction objects to meet this desirability.

Next, a second embodiment of the invention will be described.

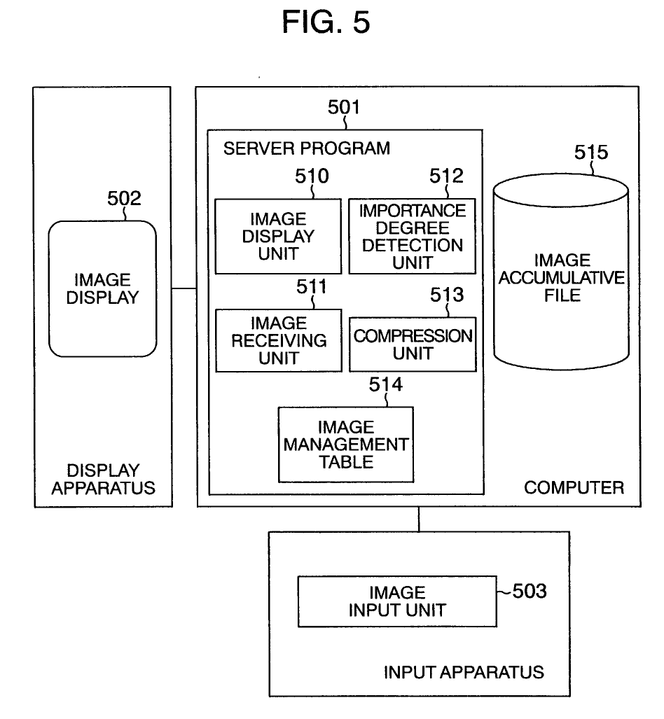

FIG. 5 is a diagram showing the overall construction of a system according to the second embodiment of the invention. In the second embodiment, images are handled in place of events representing information amount reduction (compression) objects in the first embodiment. Further, the second embodiment features in that a compression unit 513 is separated from an importance degree detection unit 512. This is because a circulated compression tool is often utilized.

The system shown in FIG. 5 comprises a computer, a display apparatus and an input apparatus. Although not illustrated, the computer may be connected to another computer or the like. The display apparatus includes an image display 502 for displaying information on the screen. The input apparatus includes an image input unit 503.

The computer on which a server program 501 is operating includes an image display unit 510, an image receiving unit 511, an importance degree detection unit 512, a compression unit 513, an image management table 514 and an image accumulative file 515.

Image files per se accumulated in the image accumulative file 515 each include, as management information, the degree of importance indicating what ratio the compression ratio is changed at and the date indicative of an image preparation date and hour. As in the case of the information amount reduction objects represented by events, the importance degree detection unit 512 acquires, every constant period, management information for images to be compressed from individual image files accumulated in the image accumulative file 515 and changes the compression ratio in accordance with the acquired importance degree and how much time has elapsed from the preparation date and hour. In some cases, as the compression ratio falls below 5%, for instance, data is erased totally. It may be decided in this manner whether information stored in the computer matches predetermined conditions and on the basis of a decision result, the information stored in the computer may be erased.

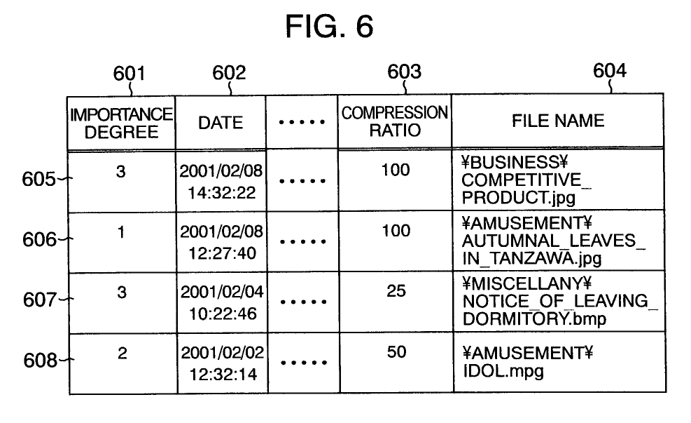

FIG. 6 shows an example of the image management table. The management table has items of importance degree 601 indicating what ratio the compression/non-compression and the compression ratio are changed at, date 602 indicative of an image preparation date and hour, compression ratio 603 and file name 604. Only the user is allowed to refer to the importance degree 601 and date 602 with the aim of preventing falsification of image life and these items are not rewritable. The compression ratio 603 and file name 604 are information obtained from compression tools or OS of each image of the corresponding importance degree 601 and date 602. In this example, compression ratios that are 100% when prepared and image storage locations are exemplified.

Data on one line in the image management table of FIG. 6 (hereinafter referred to as image management data) corresponds to one image file. The image management table will herein be described as holding items of information designated by 601 to 604 but it is not always necessary that information held on the image file side be held in the image management table.

Images corresponding to image management data 605 and 606 are of new dates and therefore they are not applied with compression regardless of their importance degrees. An image corresponding to image management data 607 has an importance degree of “3” and is aged, so that it is compressed to ¼. An image corresponding to image management data 608 is older than the image corresponding to the image management data 607 but has an importance degree of “2”, so that its compression is limited to the half.

Data having importance degrees other than “1” is compressed eventually to 0%, though depending on lengthy of the period, and at the same time the management information for image is destroyed, thereby releasing the storage area on the hard disk.

The aforementioned management information is only allowed to be consulted and is inhibited from being changed. The importance degree 601 and date 602 are inherent information used in the original form during image preparation along with the image and cannot be utilized by the tool unless the image is worked on the basis of the management information. In other words, the presenter of an image determines the utilization period (life) of the image at the time that the image is prepared.

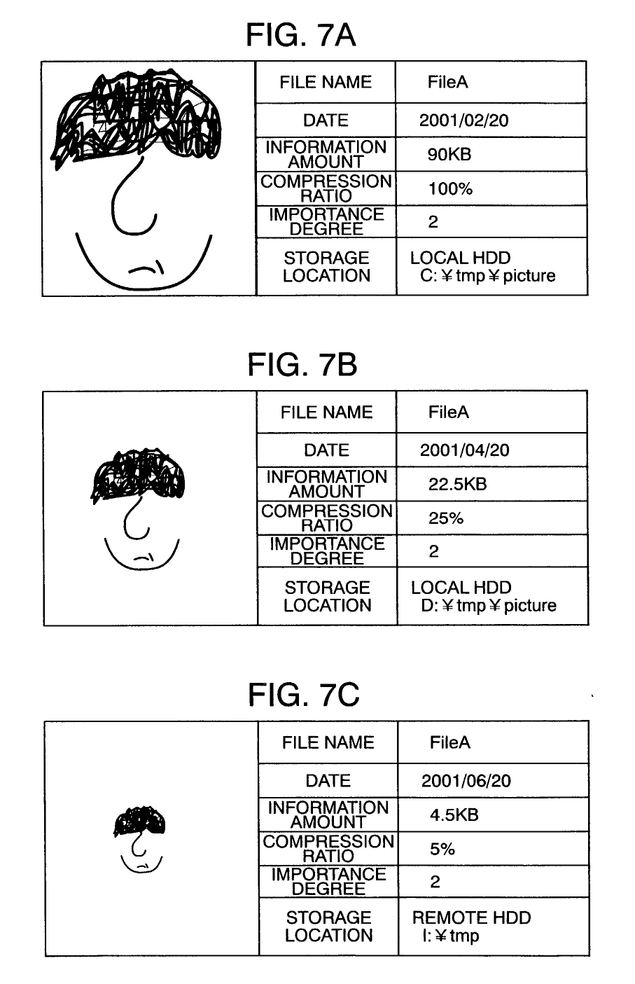

FIGS. 7A, 7B and 7C show an example in which a static image applied with the aforementioned image compression and information relating to the static image are displayed on the screen by making the correspondence between them. In the display example of FIGS. 7A to 7C, the static image is displayed in a window on the left side and the information relating to the static image is displayed in a window on the right side but other display methods than the above may be employed. Further, in the display example of FIGS. 7A to 7C, the file name, date, information amount, compression ratio, importance degree and storage location are displayed, in relation to the static image, as the information relating to the static image but the static image may be displayed by making the correspondence with information including any of them or with other information than the above.

Displays in FIGS. 7A, 7B and 7C indicate in this order temporally earlier information. As the time elapses, the disk occupation ratio decreases and the information amount of image decreases. Older information is displayed in a smaller size (thumb-nailed) to indicate its oldness, succeeding in providing displays in detail conforming to the information amount.

FIG. 7A shows a state in which the static image is stored on Feb. 20, 2001 and at that time, the storage location of a file (File A) is a local hard disk drive (C:¥tmp¥picture) and the information amount is 90 KB. FIG. 7B shows a state 2-month later than the date of FIG. 7A, namely, on Apr. 20, 2001 and at that time, the storage location of the file (File A) is a local hard disk drive (D:¥tmp¥picture) and the information amount is 22.5 KB. FIG. 7C shows a state 2-month later than the date of FIG. 7B, namely, Jun. 20, 2001 and at that time, the storage location of the file (File A) is a remote hard disk drive (I:¥tmp) and the information amount is 4.5 KB.

The memory unit can be utilized effectively by deteriorating the information with time or changing the storage location in this manner. For example, by storing data of a higher importance degree in the local hard disk drive and storing information of a lower importance degree or deteriorating information in the remote hard disk drive, the information of a higher importance degree or the not-deteriorated information can be accessed earlier. Also, by storing the information of a lower importance degree or the deteriorated information in a remote memory unit on the network, the storage capacity of the local hard disk drive can be reduced. Further, by deteriorating the information in accordance with the time and importance degree, the secondary utilization such as copy utilization of various data of, for example, voice/image can be suppressed.

Furthermore, files representing objects to be stored may be subjected to the generational management in accordance with the storage time. More particularly, FIGS. 7A, 7B and 7C may be assigned to the first generation, the second generation and third generation, respectively, so as to be stored in different storage units, the ratio of deterioration of information may be changed generation by generation, or other methods may be employed.

For example, old and deteriorated information may be erased to enable only up-to-date information to be kept in custody, or pieces of information managed generation by generation may be allowed to remain in recording units storing them, respectively, in order that histories of information deterioration can be left behind. By juxtaposing the three windows of FIGS. 7A to 7C on the screen and displaying them together, it is possible to permit the user to confirm the contents as to which image is deteriorated, how much the image is deteriorated and which recording unit the image is stored in. When the timing for displaying the contents of window is changed sequentially from FIGS. 7A to 7C in this order to provide displays inside a single window or when information is expressed by shifting it in accordance with the storing order of generation or time, the user can be allowed to see the behavior of deterioration of information in an animation fashion. Other expressional methods can also be used. In the example of FIGS. 7A to 7C, the value of priority is fixed but it may be changed as deterioration of the information proceeds, thereby displaying information stored in accordance with the value of the priority.

The example shown in FIGS. 7A to 7C is merely for explanation and document data, voice data or other kinds of data may be used. The information making the correspondence with information stored in the computer may include a date on which the information is stored in the recording unit of the computer, or a date on which the information is deteriorated in accordance with an importance degree; or when storage dates are predetermined generation by generation (for example, information of the first generation, information of the second generation . . . may be predetermined in such a way that the first generation information is information one month after a date of the first storage, the second generation information is information 3 months after the date of storage of the first generation information . . . ) , it may include information making the correspondence, every predetermined date, between information on that date and hour and deteriorated information and date information of the information. The timing for information deterioration may differ from the timing for information storage.

By assigning the utilization expiration to the digital information, the distributor can take a new distribution form and user can be released from the management work.

According to the foregoing embodiments, various kinds of digital information can be deteriorated as the time elapses. Taking digital information accumulated in the accumulative file, for instance, various kinds of information are available. Available as information of large information amount is, for example, operating history of application (log), music or image. The compression method differs with the type of information and a specified and skilled compression tool is in circulation. In the foregoing embodiments, it is possible to take advantage of characteristics such as the compression ratio and reversal/non-reversal so as to utilize them. Alternatively, unimportant items in text information such as log can be erased to reduce the information amount. To a means for erasing items in the digital information as the time elapses, the above compression tool or item erasing step may be applied.

Further, for example, when data will be backed up over a plurality of generations, back up data per se of an older generation can be erased in accordance with the lapse of time and the importance degree or can be saved to a tape for instance so as to open the precious storage space. To this end, concurrently with erase of data on one line from the management table, the back up generation may be erased or alternatively, data on one line in the management table may remain and only back up generation per se may be erased.

Furthermore, according to the foregoing embodiments, the distributor of digital information may set information such that it may be deteriorated in a distribution form of rental or trial edition as the time elapses. The life of digital information may be designated as an item value in the management table. To digital information having no life by itself, the user may give life when acquiring it. For example, the information amount may be halved every week or the halved period may be extended when the information is consulted.

Next, a third embodiment of the invention will be described.

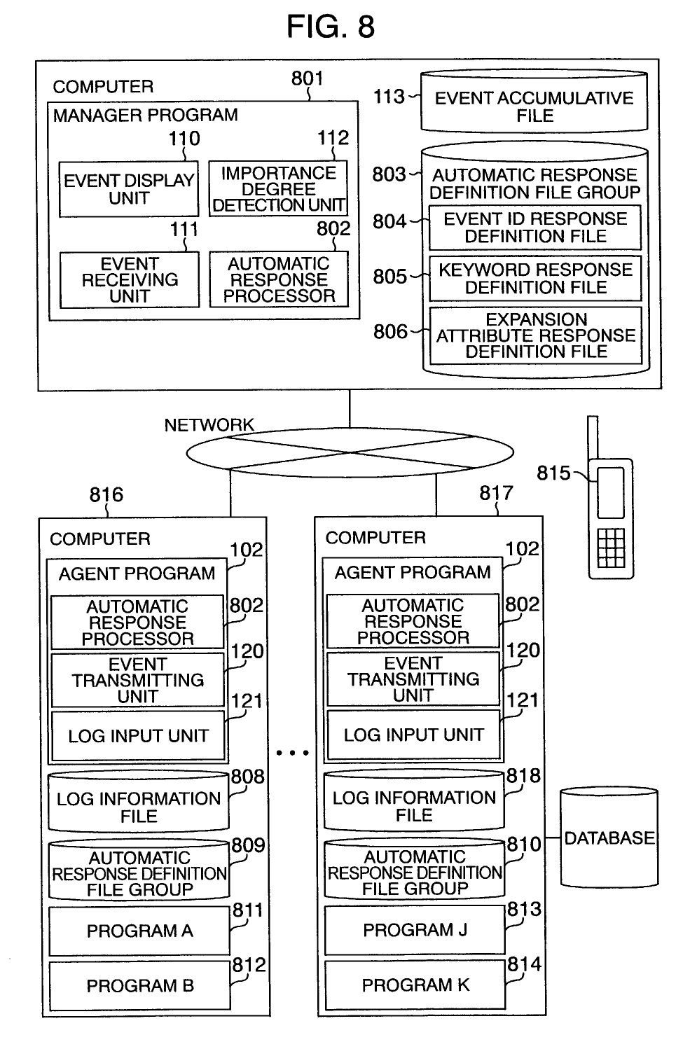

FIG. 8 is a diagram showing an example of the overall construction of a system according to the third embodiment of the invention. In the embodiment to be described below, a manager program 801 including an automatic response processor in the server program is used. Excepting the processing contents of the automatic response processor, the manager program 801 has the substantially same processing contents as that of the server program 101 or server program 501. Although not illustrated, the image display unit 510 and image receiving unit 511 may be provided in the manager program 801.

In FIG. 8, a plurality of computers are connected through a network but other system construction than above may be employed. For example, a portable terminal 815 may be used, a computer 816 and the portable terminal 815 may constitute a system capable of transmitting/receiving data, a system capable of transmitting/receiving data among a plurality of portable terminals may be employed, or other types of systems may be used.

The manager program 801 includes an event display unit 110, an event receiving unit 111, an importance degree detection unit 112 and the automatic response processor as designated by reference numeral 802. The importance degree detection unit 112 decides the degrees of importance of events stored in the event accumulative file 113 so as to deteriorate information or thin out information. The manager program 801 and respective agent programs 102 include the automatic response processors, respectively.

The automatic response processor 802 consults individual files contained in an automatic response definition file group 803 (event ID response definition file 804, keyword response definition file 805 and expansion attribute response definition file 806) and transmits the command to execute a process complying with information contained in an event.

The agent program 102 extracts information from log information of programs operating on the individual computers and transmits the extracted information as an event to the manager program 801.

The agent program 102, program A 811 and program B 812 are operating on the computer 816 and log information of the program A 811 and program B 812 is stored in a log information file 808 of the computer 816. Also stored in the computer 816 is an automatic response definition file group 809 used by the automatic response processor 802 of the agent program 102 operating on the computer 816.

The agent program 102, program J 813 and program K 814 are operating on the computer 817 and log information of the program J 813 and program K 814 is stored in a log information file 818 of the computer 817. Also stored in the computer 817 is an automatic response definition file group 810 used by the automatic response processor of the agent program 102 operating on the computer 817.

The contents of each of the aforementioned automatic response definition file groups 809 and 810 and the log information files 808 and 818 will not be detailed herein.

Each of the program A 811, program B 812, program J 813 and program K 814 may be an operating system, a program for database management, a program for on-line transaction, a program for main frame computer, a program for computer system monitoring, a program for communication control, a program for work flow system, a program for groupware or an application program such as mail software, browser and word processor, or may be other programs.

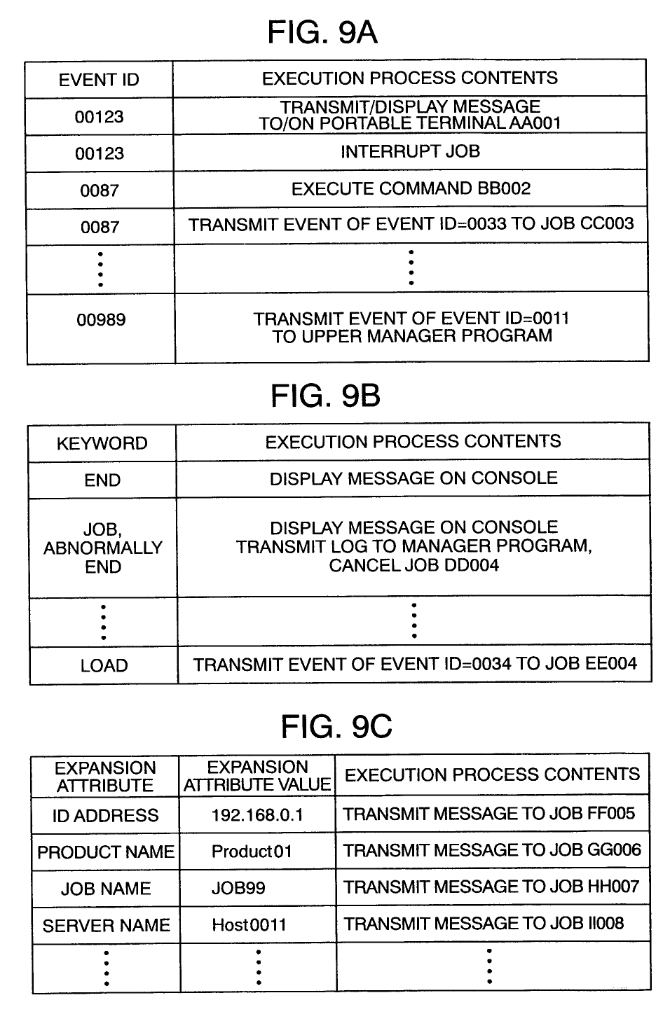

FIGS. 9A, 9B and 9C show examples of the automatic response definition file group 803.

FIG. 9A shows an example of the event ID response definition file 804, FIG. 9B shows an example of the keyword response definition file 805 and FIG. 9C show an example of the expansion attribute response definition file 806.

The event ID response definition file shown in FIG. 9A stores event ID and the contents of execution process by making the correspondence therebetween. The keyword response definition file shown in FIG. 9B stores keyword and the contents of execution process by making the correspondence therebetween. The expansion attribute response definition file shown in FIG. 9C stores expansion attribute item, expansion attribute value and the contents of execution process by making the correspondence thereamong.

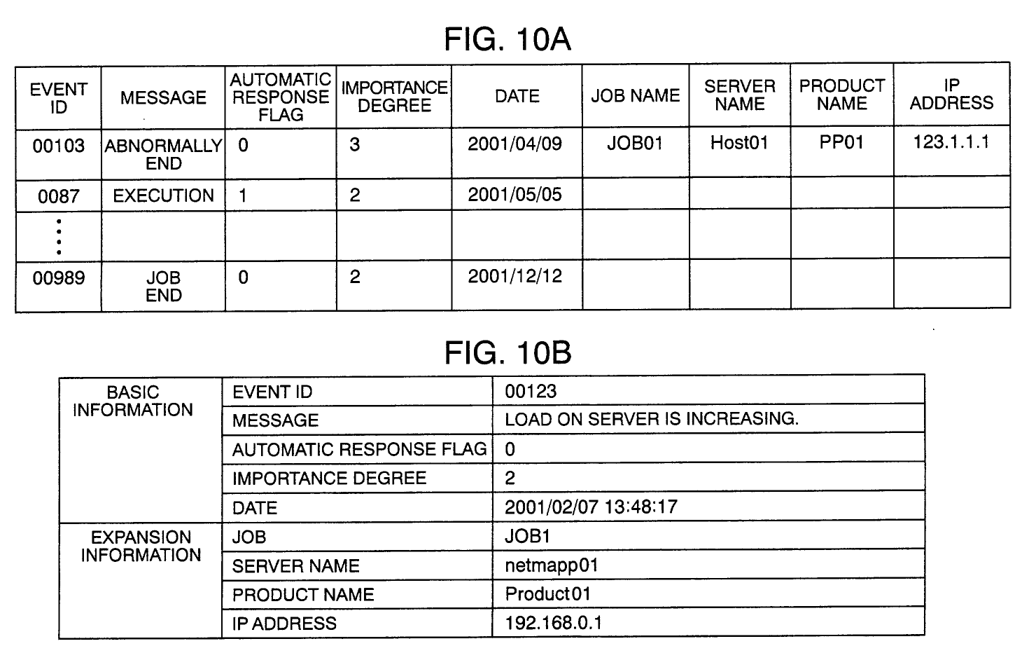

FIG. 10A shows an example of the correspondence made between event and automatic response flag and FIG. 10B shows an example in which an automatic response flag is added to the basic information in the example of event shown in FIG. 2.

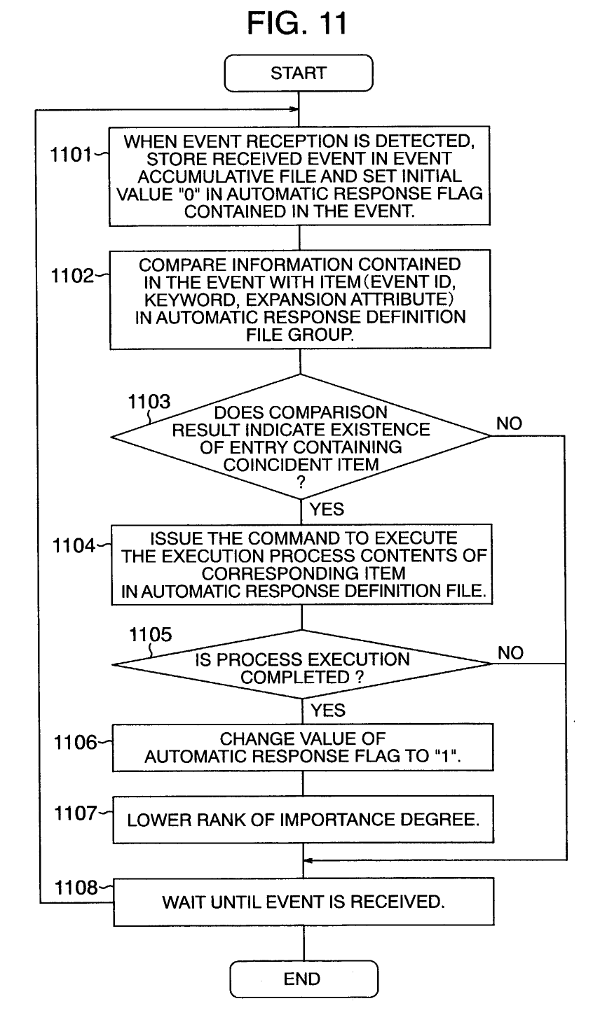

Referring to FIG. 11, there is illustrated an example of a process using the aforementioned examples of FIGS. 9A to 9C and 10A and 10B by means of the automatic response processor.

FIG. 11 shows an example of a process in the automatic response processor.

In step 1101, the event processor detecting the reception of an event stores the received event and adds an automatic response flag to the event so as to store a resulting event in the event accumulative file. In this phase, the value of automatic response flag is “0”.

In step 1102, the automatic response processor compares information contained in the aforementioned event stored in the event accumulative file with the respective items of the automatic response file group (the event ID, keyword and expansion attribute value shown in FIGS. 9A to 9C). Designated as the value of keyword is a word contained in a message stored in the event accumulative file. Any one of items of the expansion information shown in FIG. 2 (job name 221, server name 22, product name 223 or IP address 224) or a plurality of values of them may be designated as the expansion attribute value.

In step 1103, it is decided whether, as a result of the comparison in the step 1102, an entry containing a coincident item exists in the event accumulative file. In the presence of the entry containing the coincident item, the process proceeds to step 1104 but in the absence of the coincident item, the process proceeds to step 1108.

In step 1104, the command to execute the process execution contents, corresponding to an item contained in the automatic response definition file group and determined to be coincident in the step 1103, is transmitted. For example, when the event ID is “0087”, command BB002 is executed and an event having an event ID of 00333 is transmitted to a program executing job CC003 (FIG. 9A). When an event of a message containing keyword “job, abnormally ended” is stored in the event accumulative file, the message of the event is displayed on a console of the computer (such as display apparatus connected to the computer) and log information of the abnormally ended program is transmitted to another manger program so that a process for stopping the program executing the job DD004 may be carried out (FIG. 9B). Otherwise, when an event containing “192.168.0.1” in the value of expansion attribute is received and stored in the event accumulative file, a message is transmitted to a program executing job name FF005 (FIG. 9C).

In step 1105, it is confirmed whether the contents commanded to be executed in the step 1104 is completed. In this step, a process for confirming the different program as to whether the process contents transmitted to the different program is completed may be employed, a process for confirming that the process for transmission/reception of the message and log ends normally by consulting log information of a different computer may be employed or another process may be employed.

When the execution of the process defined in the automatic response definition file has completed (normally ended), the process proceeds to step 1106 but when the process is interrupted or abnormally ended, the program proceeds to the step 1108.

In case the contents of the process defined in the automatic response definition file group is determined to be completed in the step 1105, the value of automatic response flag contained in the event is changed to “1” in the step 1106.

The value of importance degree contained in the event for which the value of automatic response flag is changed to “1” in the step 1106 is changed in the step 1107. For example, when the value of importance degree contained in an event has been “2”, the importance degree value is changed to “3”.

In the step 1108, the reception of an event is awaited and upon reception of an event, the process of the step 1101 is executed.

In this manner, the automatic response processor compares the information contained in the received event with the information in the automatic response definition file group, executes the process defined in the automatic response definition file group, and changes the importance degree value of the event for which the process execution is completed to lower the rank of importance degree of the event for which the process is completed and to cause the importance degree detection unit to make the event an information reduction object, with the result that an event for which the process fails to be completed can remain as information of a high rank of importance degree.

Through this, the system custodian can consult information of a high importance-degree event for which the process is not completed from the contents of the event accumulative file and save the laborious work of management. Further, by providing the automatic response processor in each agent program and each manager program so as to enable the program of each computer to execute a process defined in the automatic response definition file group on the basis of log information or event information in the computer on which each agent program and each manager program are executed or so as to issue a command to a program operating on another computer, execution/management of processing of the program complying with the log information or event information can be achieved automatically without resort to manual operation of each computer.

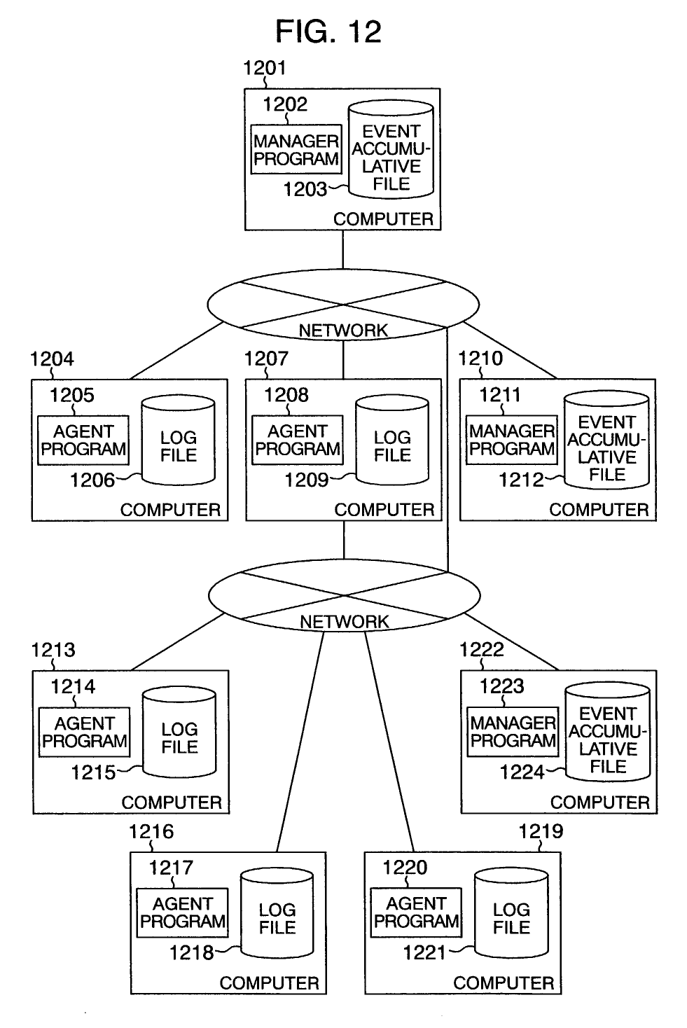

FIG. 12 is a diagram showing another example of the overall construction of the system according to the third embodiment of the invention.

Referring to FIG. 12, in a system in which a plurality of computers are connected to each other through a network, manager programs 1202, 1211 and 1223 or agent programs 1205, 1208, 1214, 1217 and 1220 are operating on the individual computers. In each of the computers on which the manager program is operating, there is provided an event accumulative file and in each of the computers on which the agent program is operating, there is provided a log file. The computers on which the manager program and the agent program are operating, respectively, have each the automatic response definition file not illustrated. The illustrated construction is a mere example and a plurality of networks may connect to each other through the medium of a network connector, for instance. Further, a device for relaying data transmission/reception to/from a portable terminal may be used.

Furthermore, the contents of the automatic response definition files stored in the individual computers may be defined differently depending on the individual manager programs or agent programs or alternatively, when the same process is executed with a plurality of agents, the contents of the automatic response definition file may be copied and stored in each computer. In storing the automatic response definition file, individual custodians of the computers may store the files in the computers, respectively, or the automatic response files may be stored in the plurality of computers by using a program for distributing data.

Each manager program has information as to whether an upper or lower manager program exists. Also, each manager program has information concerning an agent program to be monitored. An instance will be described where the computer 1201 on which the manager program 1202 is executed has, as information concerning an upper manager program, an identifier of the manager program 1223 and the manager program 1202 receives an event containing an event ID of “00989”.

In a process carried out by the manager program 1202, the manager program 1202 consults the event accumulative file group to determine that the event of event ID “00989” exists in the response definition file (FIG. 9A) and the process contents corresponding to the event ID is “an event having an event ID of “0011” is transmitted to an upper manager program”, reads the event of event ID “0011” from the event accumulative file stored in the computer on which the manager program is operating and transmits the event to the manager program 1223.

The manager program 1223 receiving the event consults the automatic response definition file group stored in the computer 1210 and according to a result of the consultation, applies execution of the execution process contents defined in the automatic response definition file group to the agent program managed by the manager program 1223 or to another manager program.

Thus, an operation cooperative with a plurality of manager program can be defined in the automatic response definition file group, so that even when a plurality of programs executed in computers connected to a network system having a complicated hierarchical structure are managed by using a manager program, a process conforming to an event received by the program can be executed without resort to manual operation.

Further, since the log data received by each manager program is processed and after reduced in information amount, the data is transmitted to another manager program, the amount of data to be managed can be decreased.

The present invention is not limited to the foregoing embodiments but for example, the following is within the framework of the invention. While the foregoing embodiments have been described by way of example of the information amount reduction (compression) object represented by images, a compression method may be used which reduces the capacity of images by using a function for reducing the number of colors or a function for extracting the contours from the image to generate a line drawing. Also, in the foregoing embodiments, an instance is described in which items of digital information are erased as the time elapses but for example, it is possible to limit the number of consulting operations or transfer operations as the time elapses.

As described above, according to the present invention, important information can be kept in the custody for a long period of time and besides the information amount of digital information can be decreased to permit it to be managed automatically. When the distributor or user determines the retention period of digital information in advance, digital information lowered in utilization value can be deteriorated as it ages to decrease the information amount, thereby ensuring that the hard disk can be utilized effectively. In addition, by making the digital information per se compressible/non-compressible or making it have a period for retaining the information amount (life), the user can be released from the management work for holding or discarding the digital information at the cost of limitation on the utilization period.

As will be seen from the above, according to the invention, by reducing the information amount of information stored in the computer in accordance with the lapse of time or the importance degree, the memory unit can be utilized effectively.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method of reducing the information amount of information stored in a computer, comprising the steps of:
deciding information of a degree of importance corresponding to the information stored in said computer; and
reducing the information amount of the information stored in said computer in accordance with a result of the decision of said information of the importance degree.

2. An information amount reducing method according to claim 1, wherein the information stored in said computer includes any of log information, event information, image data, voice data and text data.

3. An information amount reducing method according to claim 1, wherein when deciding said information of the importance degree, time information corresponding to the information stored in said computer is also decided.

4. An information amount reducing method according to claim 1, wherein when reducing the information amount of the information stored in said computer, part or the whole of the information stored in said computer is erased.

5. An information amount reducing method according to claim 4, wherein when erasing the information stored in said computer, it is decided whether the information amount of the information stored in said computer satisfies predetermined conditions and the information stored in said computer is erased on the basis of a result of the decision.

6. An information amount reducing method according to claim 1, wherein when reducing the information amount of the information stored in said computer, the information stored in said computer is deteriorated or compressed.

7. A system for reducing the information amount of information stored in a computer, comprising:
a recording unit for storing information in said computer; and
a processor for deciding information of a degree of importance and time information corresponding to the information stored in said computer and reducing the information amount of the information stored in said computer on the basis of a result of the decision.

8. A program for reducing the information amount of information stored in a computer, comprising the codes for executing the steps of:
reading the information stored in said computer and information of a degree of importance and time information corresponding to said stored information; and
reducing the information amount of said information stored in said computer on the basis of said read information.

9. A manager program executable by a computer, comprising the codes for executing the steps of:
storing an event received from an agent program in said computer;
comparing an identifier contained in said event with an identifier contained in an automatic response definition file stored in advance in said computer on which said manger program is operating;
transmitting the command to execute the execution process contents contained in said automatic response definition file to a different program, on the basis of a result of the comparison;
changing a rank of a degree of importance corresponding to said event when the execution process contents commanded to said different program in order for said different program to execute the execution process contents is completed;
deciding the importance degree corresponding to said event; and
determining on the basis of a result of the importance degree decision whether the information amount of information stored in said computer is to be reduced.

10. A manager program according to claim 9, wherein said agent program is a program operating on a computer different from that for said manager program and being adapted to transmit an event to said manager program.

11. A manager program according to claim 9, wherein said event is information concerning an event which has occurred in said computer on which said agent program is operating or in a program operating on said computer.

12. A manager program according to claim 10, wherein said event is information concerning an event which has occurred in said computer on which said agent program is operating or in a program operating on said computer.

13. A manager program according to claim 9, wherein said automatic response definition file includes any of information for making the correspondence between the identifier for identifying the event and the execution process contents, information for making the correspondence between a keyword contained in the event and the execution process contents and information for making the correspondence between an expansion attribute value contained in the event and the execution process contents.

14. A manager program according to claim 9, wherein said different program includes any of the manager program, agent program, operating system, program for database management, program for on-line transaction, program for main frame computer, program for computer system monitoring, program for communication control, program for workflow system, program for groupware, mail software, browser and word processor.

15. A manager program according to claim 9, wherein when reducing the information amount of the information stored in said computer, the information stored in said computer is deteriorated or compressed.

16. A program for displaying information stored in a computer, comprising the codes for executing the steps of:
managing the information stored in said computer, a degree of importance of said information and date information concerning said information by making the correspondence between said stored information and said importance degree information and date information;
managing information obtained by reducing the information amount of the information stored in said computer on the basis of said importance degree and date information, by making the correspondence between said information reduced in information amount and a degree of importance and date information of said information reduced in information amount; and
displaying the information stored in said computer and the information obtained by deteriorating the information stored in said computer on the basis of the date information or importance degrees of said information and said deteriorated information.

17. A program for displaying information stored in a computer according to claim 16, wherein when displaying the information stored in said computer and the information obtained by deteriorating the information stored in said computer, the importance degree of said information, the information amount of said information and the storage location of said information are displayed by making the correspondence between said information and its importance degree, information amount and storage location, respectively.

18. A program for displaying information stored in a computer according to claim 16, wherein when displaying information on the basis of said date information, the information stored in said computer and the information obtained by deteriorating the information stored in said computer are displayed by disposing them on the basis of their date information.

19. A program for displaying information stored in a computer according to claim 16, wherein when displaying information on the basis of said date information, the information stored in said computer and the information obtained by deteriorating the information stored in said computer are displayed in the same window by shifting them in order of their date information.
